(19) United States
(12) Patent Application Publication
(10) Pub. No.: US 2010/0037104 A1
(43) Pub. Date: Feb. 11, 2010

(54) IMAGE FORMING APPARATUS AND METHOD OF CONTROLLING APPLICATION THEREOF

(75) Inventors: Jung-woon Jung, Suwon-si (KR); Eun-sook Kang, Suwon-si (KR); In-hwan Cho, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/469,845

(22) Filed: May 21, 2009

(30) Foreign Application Priority Data
Aug. 5, 2008 (KR) 2008-0076708

(51) Int. Cl. G06F 11/07; G06F 3/048

(52) U.S. Cl. 714/49; 715/772; 714/E11.024; 714/E11.025

(57) ABSTRACT

A method to control an application installed on an image forming apparatus includes checking current status information of the image forming apparatus, comparing the checked current status information with executability information to execute a pre-stored application, and if the application is executable as a result of the comparing, executing the application, and if the application is not executable, displaying information that the application is not executable.

### CROSS-REFERENCE TO RELATED APPLICATIONS

This application claims priority under 35 U.S.C. §119(a) from Korean Patent Application No. 10-2008-0076708, filed on Aug. 5, 2008, in the Korean Intellectual Property Office, the disclosure of which is incorporated herein by reference in its entirety.

### BACKGROUND

1. Field of the Invention

The present general inventive concept relates to an image forming apparatus and a method of controlling an application thereof. More particularly, the present general inventive concept relates to an image forming apparatus to check a current status thereof and determine whether to execute a widget program, and a controlling method thereof.

2. Description of the Related Art

Widget programs can be designed to provide various functions such as stock trading guide, clock or calculator, or distributed to display devices through networks to provide information.

The widget programs can also be installed in an image forming apparatus to provide a user with a variety of information. An image forming apparatus that supports appropriate working environments can execute the target widget program.

However, since the image forming apparatus performs various functions and its operation environments frequently change according to network status, a widget program, which was once executed on the image forming apparatus, can become non-executable at certain points with respect to the changed functions and operation environments. If this happens, a user unfamiliar with programs has difficulty understanding the cause of problem.

### SUMMARY

The present general inventive concept provides an image forming apparatus to check current status thereof and determining whether to start the application, and a method of controlling an application thereof.

Additional features and utilities of the present general inventive concept will be set forth in part in the description which follows and, in part, will be obvious from the description, or may be learned by practice of the general inventive concept.

Embodiments and utilities of the present general inventive concept can be achieved by providing a method of controlling an application installed on an image forming apparatus, the method including checking current status information of the image forming apparatus, comparing the checked current status information with executability information to execute a pre-stored application, and executing the application if the application is executable as a result of the comparing, or displaying information that the application is not executable if the application is not executable as a result of the comparing.

The method may further include receiving an application and the executability information of the application from an external device, and storing the received information.

The executability information may be received when a command to execute a pre-stored application is input, when the image forming apparatus is turned on or when a predetermined time elapses.

The method may further include displaying information that the comparing operation to execute the application is in process.

The displaying may include displaying that the pre-stored application is not executable, or a reason for non-executability of the application.

The displaying may include displaying a user interface to provide the executability of the pre-stored application and the reason for non-executability if the application is not executable in an initial screen.

The method may further include executing the application if a command to execute the application is input in which the displaying includes displaying the information that the application is not executable according to the result of the comparing.

The current status information may include at least one of platform information to execute the application, a network status, a memory status, and a presence of function module required for executing the application.

The executability information may include at least one of an application version, application function information, and a memory capacity required for executing the application.

Embodiments and utilities the present general inventive concept can also be achieved by providing an image forming apparatus that may include a storage unit to store an application received from an external device and executability information of the application, a display unit, and a control unit to compare current status information of the image forming apparatus with the executability information, and to execute the application if the application is executable as a result of the comparing, or display information regarding the non-executability of the application if the application is not executable.

The control unit may receive the executability information from the external device and stores the received information when a command to execute a pre-stored application is input, when the image forming apparatus is turned on, or when a predetermined time elapses.

The control unit may control the display unit to display information that the comparing operation to execute the application is in process.

The control unit may control the display unit to display whether or not the pre-stored application is executable, or a reason for non-executability if the application is not executable.

The control unit may display a user interface (UI) to display the executability of the pre-stored application and the reason for non-executability if the application is not executable in an initial screen.

The control unit may control the display unit to display the information that the application is not executable according to the result of the comparing, if a command to execute the application is input.

The current status information may include at least one of: platform information to execute the application; a network status; a memory status; and a presence of function module required for executing the application.

The executability information may include at least one of: an application version; application function information; and a memory capacity required for executing the application.

Embodiments and utilities of the present general inventive concept can also be achieved by providing a method of controlling an application installed in an image forming apparatus the method including determining whether the application is executable according to an environment of the image forming apparatus and information of the application, and generating a user interface displayable on a display unit about the determination.

Embodiments and utilities of the present general inventive concept can also be achieved by providing an image forming apparatus to store and execute at least one application that may include a display unit to display a user interface to receive user input, and a control unit to determine whether the application is executable according to an environment of the image forming apparatus and information of the application.

The image forming apparatus may also include an image forming unit to perform an image forming operation, wherein the control unit may control the image forming unit and the display unit according to the determination of the control unit or the user input of the user interface.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating image forming apparatus according to an exemplary embodiment of the present general inventive concept;

FIGS. 2A and 2B are views illustrating metadata according to an exemplary embodiment of the present general inventive concept;

FIGS. 3A to 3E are views illustrating a method of controlling an application of an image forming apparatus according to an exemplary embodiment of the present general inventive concept; and

FIG. 4 is a flowchart illustrating a method of controlling an application of an image forming apparatus according to an exemplary embodiment of the present general inventive concept.

### DETAILED DESCRIPTION OF THE EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

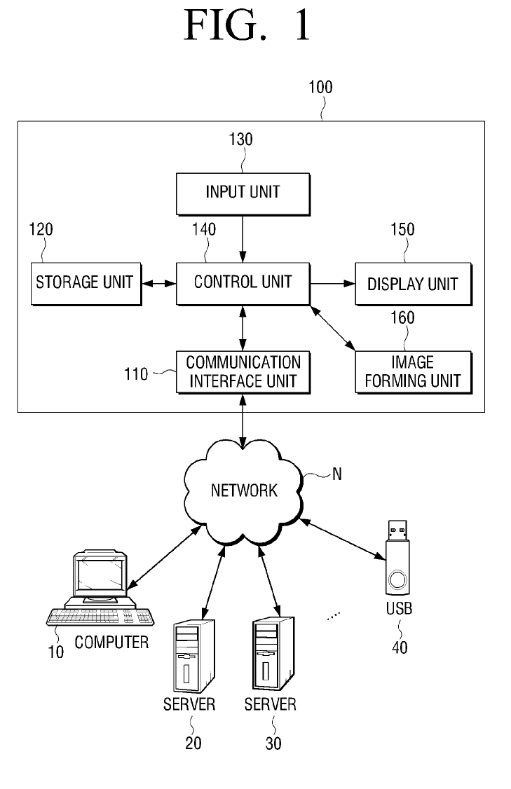

FIG. 1 is a block diagram illustrating an image forming apparatus 100 according to an exemplary embodiment of the present general inventive concept. Referring to FIG. 1, the image forming apparatus 100 includes a communication interface unit 110, a storage unit 120, an input unit 130, a control unit 140, a display unit 150, and an image forming unit 160.

The image forming unit 160 may include elements to feed a printing medium to form or print an image on the printing medium according to print data stored in the storage unit 120, print data input from the input unit 130, and/or print data received from the network through the communication interface unit 110 under control of the control unit, and to discharge the printing medium with the image outside the image forming apparatus 100 as an image forming operation. The image forming apparatus 100 may further include elements to perform a faxing operation, a scanning operation, and/or a copy operation. The above-described operations are well known. Therefore, detailed descriptions thereof will be omitted.

The communication interface unit 110 connects a plurality of external devices 10˜40 wirelessly or wired to the image forming apparatus 100 through a network N and receives at least one application and executability information about the corresponding application. The external devices may include a host device 10, web servers 20 and 30 to provide a plurality of applications, or a storage medium 40 to store a plurality of applications.

The communication interface unit 110 may connect the host device 10 directly through a parallel port, a universal serial bus (USB), a wired or wireless interface, or the like.

For example, the application may be a widget program used by a computer application program developer or an Internet portal site provider to provide a user with user-tailored information. A utility program will be explained below, as an example of the widget program.

The storage unit 120 may include a read only memory (ROM) and a random access memory (RAM), in which the ROM stores therein one or more widget programs and various control programs necessary to drive the image forming apparatus, with a platform to execute at least one widget program received from the external devices 10˜40. The RAM stores therein various variable data such as data processed by the control unit 140, programs loaded from the ROM, the printing data, etc.

The widget program may generally provide information about particular topics, such as weather, stock trading, or traffic. The widget program may also be provided as a shortcut key for a basic function supported by the image forming apparatus 100, such as scanning, copying or printing.

The widget program and executability information about the widget program may be received in the form of metadata. Alternatively, the executability information alone may be in the form of metadata, when the widget program and the executability information are received. In other words, metadata may include executability information or a widget program and executability information.

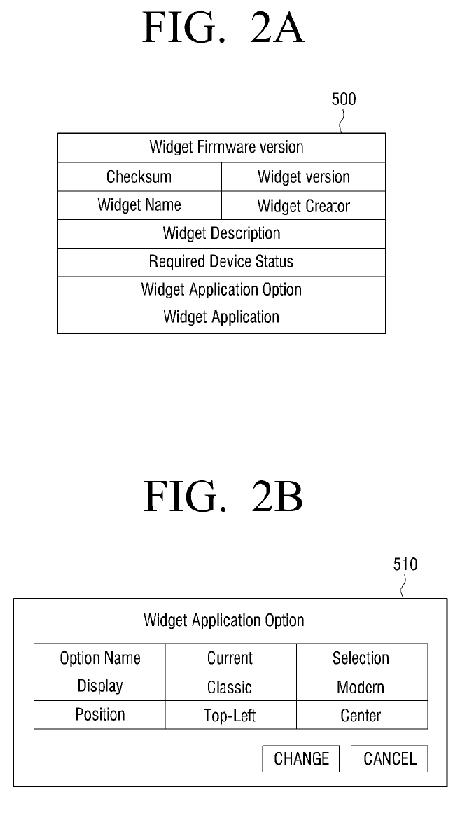

The metadata of the executability information may be received by the control unit 140 from the external devices 10˜40 upon: starting a determination as to whether to execute a pre-stored widget program, turning on the image forming apparatus 100, or a predetermined time period after the image forming apparatus 100 is turned on. However, the present general inventive concept is not limited thereto. An example of the metadata will be explained below with reference to FIG. 2A.

FIG. 2A illustrates metadata 500 to explain the executability information of an application according to an exemplary embodiment of the present general inventive concept. Referring to FIG. 2A, the metadata 500 received from the external devices 10˜40 may include a widget program version, a widget name, a widget creator, widget program function information, a required status for device execution, extra options, a widget firm ware version, a checksum, widget description, or an actual widget program. The information of the metadata 500 is not limited to the format illustrated in FIG. 2A, but changeable by a widget developer. Metadata 500 may include executability information and the widget program, which can be transmitted separately from each other and to be received separately in the image forming apparatus 100.

The widget program function information may include a widget name, a widget language, a communication protocol such as HTTP, FTP, or SOAP, or explanation about the function details. The required status for device execution includes a memory status of the device (for example, the memory status of the image forming apparatus 100), a network status, or function modules required for executing a widget.

Referring to FIG. 2B, extra options 510 relate to a display form or a position of the widget program, which is changeable by a user, with respect to a screen of the display unit. For example, a variable or adjustable display form may be provided so that a user may select a preferential display form. Additionally, a centered position or a top-left position may be provided so that a user may select a preferential location of the widget program on the display unit 150.

The control unit 140 controls the overall operation of the image forming apparatus 100 using the stored control programs. If a request for displaying a plurality of widget program items is received through the input unit 130, the control unit 140 reads out the plurality of widget programs from the storage unit 120 and provides a corresponding user interface (UI) through the display unit 150 so that the user can select one of the widget programs.

Accordingly, the display unit 150 displays the UI provided from the control unit 140. The display unit 150 may be embodied as a liquid crystal panel (LCD), and may display the current status information of the image forming apparatus 100 according to the control of the control unit 140.

For example, the display unit 150 may display one or more items of a plurality of widget programs which are processed to a displayable form, such as in texts or images. When a user selects one of the widget programs, the display unit 150 displays, under the control of the control unit 140, detailed information about the selected widget program, or a message, list or image to notify the user that the selected widget program is not executable.

The control unit 140 checks the current status information of the image forming apparatus 100 and compares the current status information with the stored executability information. The current status information may include platform information to execute a widget program, a network status, a memory status, or a presence or absence of the required function modules to execute a widget program. The platform information may include a platform version, a communication protocol, or translatable program language support information. The network information may include a connection status to an external device, a network connection or a disconnection, an IP collision, or a USB connection. The memory status may include a remaining memory capacity.

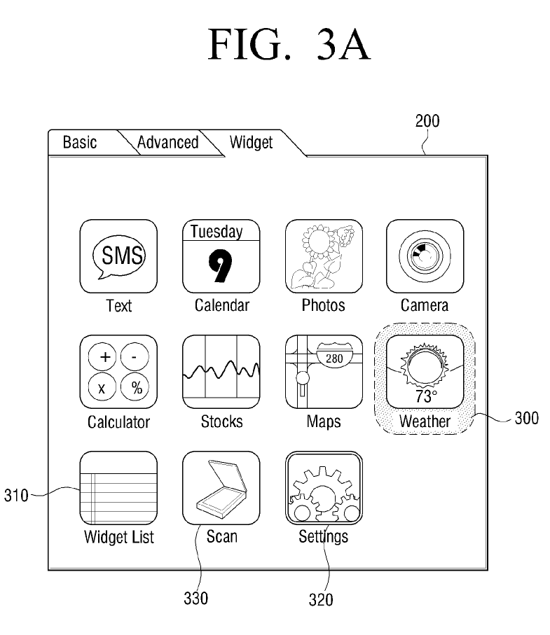

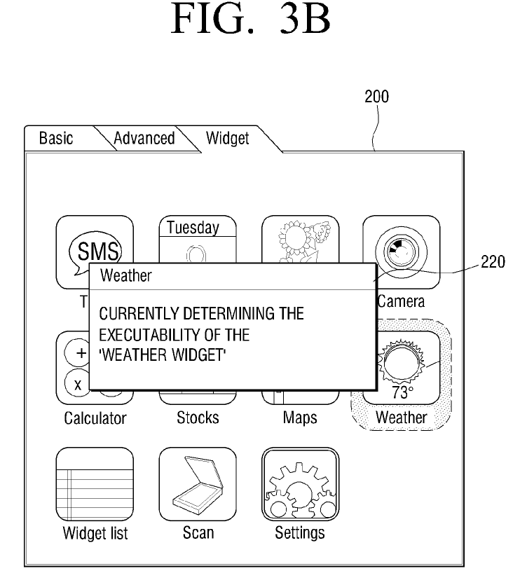

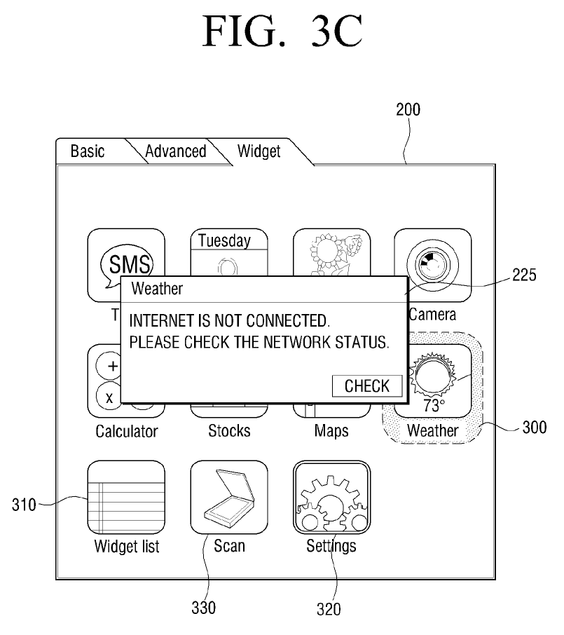

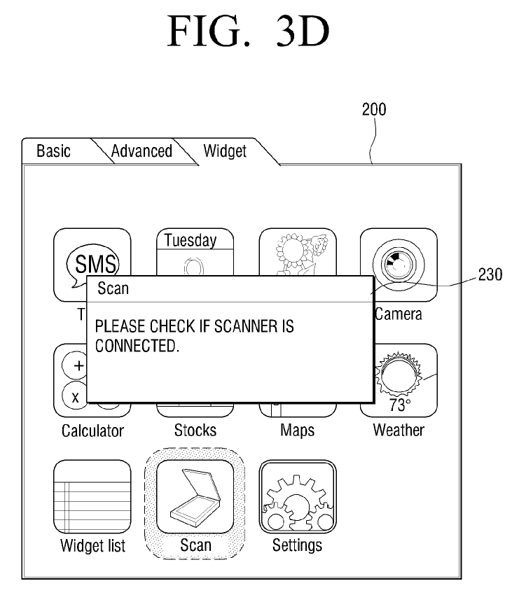

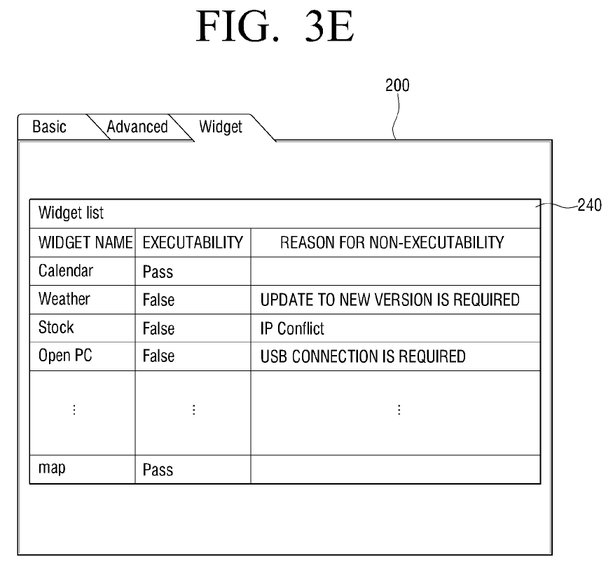

The operations at the control unit 140 to determine whether or not to execute a widget program, and to control in the case of determining non-executability, will be explained in greater detail below with reference to FIGS. 3A to 3E.

FIGS. 3A to 3E are views illustrating a widget program control method of an image forming apparatus according to an exemplary embodiment of the present general inventive concept.

FIG. 3A illustrates a user interface (UI) 200, which is displayed as the image forming apparatus 100 is turned on and the display unit 150 is initialized. The display unit 150 may display a basic UI which provides a UI related to the basic functions of the image forming apparatus 100, such as printing, copying or scanning. The display unit 150 may also display an advanced UI to provide a UI related to extra options, and a widget UI to provide a UI related to a widget program.

According to FIG. 3A, the widget program items stored in the storage unit 120 are displayed as icons in an initial screen of the widget UI. Here, one of the three types of UI's, basic, advanced, or widget, are selected. FIG. 3A illustrates the widget UI being selected.

Specifically, the widget UI displays icons of various widgets, such as a widget list 310, a setting widget 320, or a scan widget 330 corresponding to a shortcut key for basic functions of the image forming apparatus 100. For example, a user may select a weather widget program 300 from the widget UI as the target widget program. The weather widget program 300 may be highlighted when being selected.

The widget list 310 will be explained below with reference to FIG. 3E. A program related to the setting widget 320 may include a user-definable area with respect to the widget program.

FIG. 3B illustrates a notification that the executability of the selected target widget program 300 is being determined. According to FIG. 3B, if a user selects the weather widget program 300, the control unit 140 determines the current status information of the image forming apparatus 100.

Additionally, based on the executability information of the weather widget program 300 stored in the storage unit 120, the control unit 140 determines whether the weather widget program 300 is executable or not.

More specifically, the control unit 140 checks the version of the weather widget program 300 to determine whether or not the weather widget program 300 can be executed on a platform provided by the image forming apparatus 100. The control unit 140 also checks function information or platform information of the image forming apparatus 100 to determine whether there is translatable program supporting information to support the weather widget program 300, and also to determine if the image forming apparatus 100 has an operating environment that allows access to a web server that provides weather information. The control unit 140 also determines whether it is possible to ensure a sufficient memory space to execute the weather widget program 300. The control unit 140 may additionally compare and determine other variable operating environments of the image forming apparatus 100.

During the abovementioned comparing process, a message 220 may be disposed to notify a user so that the control unit 140 is currently comparing the executability information stored in the storage unit 120 with the current status information of the image forming apparatus 100. Here, when an icon representing the weather widget program 300 is selected, the message 220 can be generated by the control unit 140 and displayed on the display unit 150 through the UI interface 200.

FIGS. 3C and 3D illustrate a screen provided when the selected target program is not executable. According to FIG. 3C, a popup message 225 may be displayed to notify a user that the weather widget program 300 is not executable due to failure to connect to the Internet.

FIG. 3D illustrates an example where the scan widget 330 is selected, but determined to be non-executable as a result of executability determination at the control unit 140. Thus, a message 230 is displayed, informing a user that the scan widget 330 is not executable due to an absence of a connected scanner.

FIG. 3E illustrates a list 240 of a plurality of widget programs stored as the initial screen of the widget UI, whether each widget program is executable, and the reason if the widget program is not executable. The list 240 may be updated according to the executability check of the control unit 140. When the image forming apparatus 100 is turned on, when a user selects the widget UI, or when a predetermined time elapses.

The list 240 of FIG. 3E may be displayed when the widget list program item 310 of FIG. 3A is selected.

Furthermore, if the name of the executable widget program is selected from the list 240, the executability of the corresponding widget program is determined, and may provide the widget information or display the reason for non-executability. When the list 240 is selected, other icons or other widget programs may not be displayed on the screen, but the list 240 is displayed.

Accordingly, a user can easily access information as to whether the image forming apparatus 100 being used has a status that allows a user to execute a widget program on.

According to the present general inventive concept, a widget program is received or stored in the image forming apparatus 100 to perform a program corresponding to the widget program. When the widget program is intended to be performed in a first environment (status) of the image forming apparatus 100, and when the first environment of the image forming apparatus 100 is changed to a second environment, it is possible that there is a conflict between the performance or execution of the widget program and the second environment of the image forming apparatus 100. In this case, the control unit 140 generates a UI to inform a user that the image forming apparatus 100 has a status that does not allow the user to execute the widget program.

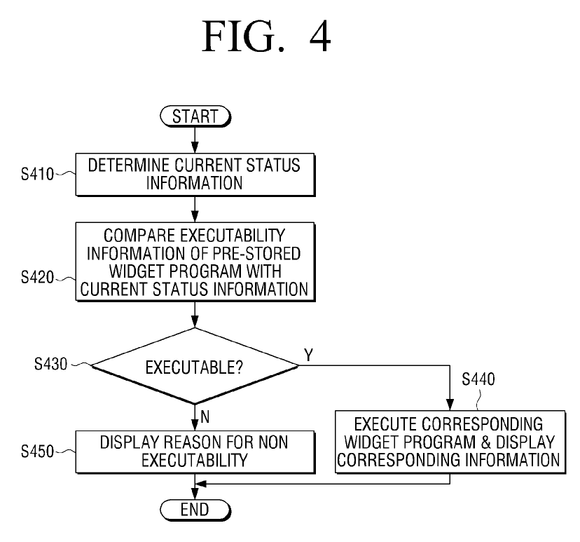

FIG. 4 is a flowchart illustrating a widget program control method of the image forming apparatus 100 according to an exemplary embodiment of the present general inventive concept. Referring to FIG. 4, the current status information of the image forming apparatus 100 is determined at operation S410. Operation S410 may be executed when the user selects a target widget program, when the image forming apparatus 100 is turned on, when the widget UI is selected, or when a predetermined time elapses.

The obtained current status information of the image forming apparatus 100 is then compared with the pre-stored widget program executability information at operation S420, to determine whether or not the widget program is currently executable at operation S430. The process of checking executability of the widget program is performed at operation S430, as substantially described herein.

If the user selects a target widget program and the selected widget program is determined to be executable, the corresponding widget program is executed and the corresponding information is displayed at operation S440.

If the selected widget program is determined to be non-executable, the fact that the widget program is not executable, or the reason for non-executablity, or both is displayed at operation S450. If the user inputs a command to execute the target widget program and the target widget program is determined to be executable, the user may be notified of the result of the determination in the form of a popup message.

Meanwhile, a list 240, including all the widget programs stored, their executability, and the reason for non-executability if the widget program is not executable, may be provided when the image forming apparatus 100 is turned on, when the widget UI is selected, or when a predetermined time elapses, so that the user can easily obtain the current status of the widget programs.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, Blu-Ray discs, magnetic tapes, floppy disks, optical data storage devices, and the like. The computer-readable recording medium can also be distributed over network coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

According to the present general inventive concept, it is possible that the computer-readable codes of the computer readable medium to perform the above described method, and the widget program, such as metadata, can be transmitted from the external device, such as computer 10, server 20, server 30, USB 40, etc., to the image forming apparatus 100 through the network N, and stored in the storage unit 120.

Although exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A method of controlling an application installed in an image forming apparatus, comprising:
checking current status information of the image forming apparatus;
comparing the checked current status information with executability information to execute a pre-stored application; and
executing the application if the application is executable as a result of the comparing, or displaying information that the application is not executable if the application is not executable as a result of the comparing.

2. The method of claim 1, further comprising:
receiving an application and the executability information of the application from an external device; and
storing the received information.

3. The method of claim 2, wherein the executability information is received when a command to execute a pre-stored application is input when the image forming apparatus is turned on or when a predetermined time elapses.

4. The method of claim 1, further comprising:
displaying information that the comparing operation to execute the application is in process.

5. The method of claim 1, wherein the displaying comprises displaying that the pre-stored application is not executable, or a reason for non-executability of the application.

6. The method of claim 5, wherein the displaying comprises displaying a user interface to provide the executability of the pre-stored application and the reason for non-executability if the application is not executable in an initial screen.

7. The method of claim 1, further comprising:
executing the application if a command to execute the application is input, in which the displaying comprises displaying the information that the application is not executable according to the result of the comparing.

8. The method of claim 1, wherein the current status information comprises at least one of platform information to execute the application, a network status, a memory status, and a presence of function module required for executing the application.

9. The method of claim 1, wherein the executability information comprises at least one of: an application version; application function information; and a memory capacity required for executing the application.

10. An image forming apparatus comprising:
a storage unit to store an application received from an external device and executability information of the application;
a display unit; and
a control unit to compare current status information of the image forming apparatus with the executability information, and to execute the application if the application is executable as a result of the comparing, or display information regarding non-executability of the application if the application is not executable.

11. The image forming apparatus of claim 10, wherein the control unit receives the executability information from the external device and stores the received information when a command to execute a pre-stored application is input, when the image forming apparatus is turned on, or when a predetermined time elapses.

12. The image forming apparatus of claim 10, wherein the control unit controls the display unit to display information that the comparing operation to execute the application is in process.

13. The image forming apparatus of claim 10, wherein the control unit controls the display unit to display whether or not the pre-stored application is executable, or a reason for non-executability if the application is not executable.

14. The image forming apparatus of claim 13, wherein the control unit displays a user interface (UI) to display the executability of the pre-stored application and the reason for non-executability if the application is not executable in an initial screen.

15. The image forming apparatus of claim 10, wherein the control unit controls the display unit to display the information that the application is not executable according to the result of the comparing, if a command to execute the application is input.

16. The image forming apparatus of claim 10, wherein the current status information comprises at least one of platform information to execute the application, a network status, a memory status, and a presence of function module required for executing the application.

17. The image forming apparatus of claim 10, wherein the executability information comprises at least one of an application version, application function information, and a memory capacity required for executing the application.

18. A method of controlling an application installed in an image forming apparatus, the method comprising:
determining whether the application is executable according to an environment of the image forming apparatus and information of the application; and
generating a user interface displayable on a display unit about the determination.

19. An image forming apparatus to store and execute at least one application, the image forming apparatus, comprising:
a display unit to display a user interface to receive user input; and
a control unit to determine whether the application is executable according to an environment of the image forming apparatus and information of the application.

20. The image forming apparatus of claim 19, further comprising:
an image forming unit to perform an image forming operation, wherein the control unit controls the image forming unit and the display unit according to the determination of the control unit or the user input of the user interface.
